(19) United States
(12) Patent Application Publication
(10) Pub. No.: US 2025/0023302 A1
(43) Pub. Date: Jan. 16, 2025

(54) CONNECTOR

(71) Applicant: BIZLINK INTERNATIONAL CORP., New Taipei City (TW)

(72) Inventors: Yi-Hsing CHUNG, New Taipei City (TW); Yen-Chun CHEN, New Taipei City (TW)

(21) Appl. No.: 18/770,684

(22) Filed: Jul. 12, 2024

(30) Foreign Application Priority Data
Jul. 12, 2023 (TW) 112126098

(51) Int. Cl. H01R 13/6591; H01R 12/70

(52) U.S. Cl. CPC H01R 13/65914; H01R 12/707

(57) ABSTRACT

A connector includes a circuit board, signal wires, and a ground bar. The circuit board has an upper surface and a lower surface opposite to each other. The upper surface includes upper signal contacts and upper ground contacts. The lower surface includes lower signal contacts and lower ground contacts. Some of the signal wires are in contact with the upper signal contacts respectively. Others of the signal wires are in contact with the lower signal contacts respectively. The ground bar is in contact with the upper ground contacts and the lower ground contacts.

### CROSS-REFERENCE TO RELATED APPLICATION

This application claims priority to Taiwan Application Serial Number 112126098, filed Jul. 12, 2023, which is herein incorporated by reference.

### BACKGROUND

### Technical Field

The present disclosure relates to a connector, and more particularly, to a high-speed connector for servers.

### Description of Related Art

The disclosed prior art CN108736186B provides a connector with a ground bar. The ground bar connected to a drain wire (ground wire) provides a grounding effect. However, the above-mentioned connector has a plurality of the ground bars. Multiple ground bars need to be connected to a circuit board and drain lines on upper and lower surfaces respectively, which results in complicated assembly steps during manufacturing because the multiple ground bars need to be installed separately.

Therefore, how to propose a connector that can solve the above problems is one of the problems that the industry is currently eager to invest in research and development resources to solve.

### SUMMARY

In view of this, one purpose of the present disclosure is to provide a connector that can solve the above problems.

The present disclosure relates to a connector, which includes a circuit board, signal wires, and a ground bar (also called a ground bus). The circuit board has an upper surface and a lower surface opposite to each other. The upper surface includes a plurality of upper signal contacts and a plurality of upper ground contacts. The lower surface includes a plurality of lower signal contacts and a plurality of lower ground contacts. Some of the signal wires are in contact with the upper signal contacts respectively. Others of the signal wires are in contact with the lower signal contacts respectively. The ground bar is in contact with the upper ground contacts and the lower ground contacts.

In some embodiments, the ground bar includes an upper portion, a sidewall portion, and a lower portion. The upper portion is in contact with the upper ground contacts. The sidewall portion is connected to the upper portion and the lower portion. The lower portion is in contact with the lower ground contacts.

In some embodiments, at least one of the signal wires includes a differential pair and a shielding film surrounding the differential pair. The shielding film is electrically connected to the ground bar. Exposed portions of the shielding film are located between the upper portion and the lower portion.

In some embodiments, at least one of the signal wires includes a differential pair. The sidewall portion has a through hole corresponding to the differential pair. The differential pair passes through the through hole and is electrically connected to the circuit board.

In some embodiments, at least one of the upper portion and the lower portion includes a main panel connected to the sidewall portion and a plurality of finger portions connected to the main panel. The finger portions extend away from the sidewall portion.

In some embodiments, the finger portions and the signal wires are arranged alternately.

In some embodiments, the circuit board has a side surface connected to the upper surface and the lower surface. The sidewall portion faces the side surface.

In some embodiments, each of the signal wires includes a differential pair and a shielding film surrounding the differential pair. The ground bar has a plurality of soldering openings. The soldering openings respectively correspond to the differential pairs. The soldering openings expose the shielding film.

In some embodiments, the ground bar further includes at least one solder groove. The at least one solder groove is communicated with the soldering openings.

In some embodiments, the ground bar is a C-shaped structure. Two ends of the C-shaped structure clamp on the upper surface and the lower surface respectively.

The present disclosure relates to a connector, which includes a circuit board and a ground bar. The circuit board has an upper surface and a lower surface opposite to each other. The upper surface includes a plurality of upper signal contacts and a plurality of upper ground contacts. The lower surface includes a plurality of lower signal contacts and a plurality of lower ground contacts. Two ends of the ground bar clamp on the upper surface and the lower surface respectively and are in contact with the upper ground contacts and the lower ground contacts respectively.

In some embodiments, the ground bar includes an upper portion, a sidewall portion, and a lower portion. The upper portion is in contact with the upper ground contacts. The sidewall portion is connected to the upper portion and the lower portion. The lower portion is in contact with the lower ground contacts.

In some embodiments, at least one of the upper portion and the lower portion includes a main panel connected to the sidewall portion and a plurality of finger portions connected to the main panel. The finger portions extend away from the sidewall portion.

In some embodiments, the sidewall portion has a plurality of through holes. The through holes are sequentially arranged in pairs on the sidewall portion.

In some embodiments, the ground bar has a plurality of soldering openings and at least one solder groove communicated with the soldering openings.

To sum up, in the connector of the present disclosure, the ground bar has the upper portion, the sidewall portion, and the lower portion connected to each other. The ground bar is in contact with the ground contacts on both the upper surface and the lower surface of the circuit board. In this way, when manufacturing the connector, you only need to clamp the C-shaped ground bar on the circuit board, and then use a machine to simultaneously solder the ground contacts on the upper surface and the lower surface of the circuit board, thereby improving process efficiency.

These and other aspects of the present disclosure will become apparent from the following description of preferred embodiments, taken in conjunction with the accompanying drawings. However, changes and modifications may be made therein without departing from the spirit and scope of the novel concepts of the present disclosure.

### BRIEF DESCRIPTION OF THE DRAWINGS

The drawings illustrate one or more embodiments of the present disclosure and, together with the written description, serve to explain principles of the present disclosure. Wherever possible, the same reference symbols are used throughout the drawings to refer to similar or identical elements of the embodiments.

FIG. 1 is a perspective view of a connector according to an embodiment of the present disclosure;

FIG. 2 is an exploded view of the connector according to an embodiment of the present disclosure;

FIG. 3A is a perspective view of a ground bar according to an embodiment of the present disclosure;

FIG. 3B is a partial perspective view of the ground bar according to an embodiment of the present disclosure;

FIG. 4A is a top view of a circuit board according to an embodiment of the present disclosure;

FIG. 4B is a bottom view of the circuit board according to an embodiment of the present disclosure;

FIG. 5 is a partial perspective view of the connector according to an embodiment of the present disclosure; and

FIG. 6 is a side view of the connector according to an embodiment of the present disclosure.

### DETAILED DESCRIPTION

The following disclosure will now be described more fully herein by drawings and references, in which some exemplary embodiments are shown. The present disclosure may be implemented in different forms and should not be limited by the embodiments mentioned below. However, these embodiments are provided to facilitate a more complete understanding of the disclosure and to fully convey the scope of the disclosure to those skilled in the art. The same reference symbols will be used throughout the present disclosure to refer to similar elements.

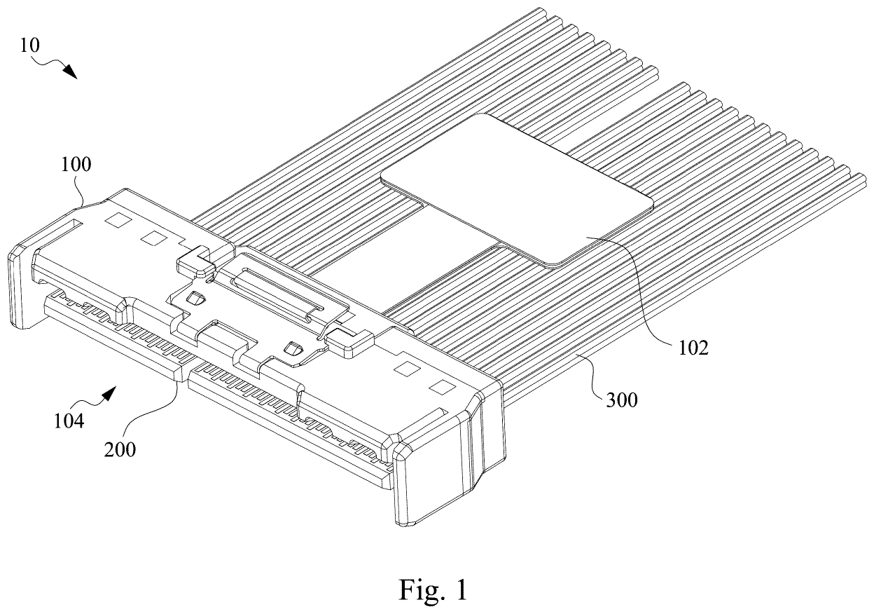

It should be noted that the drawings in FIG. 1 to FIG. 6 are drawn to true scale. In order to keep the description concise, the proportions of each component are not listed one by one, but the proportions and positions of each component should be regarded as part of the content of this description.

As shown in FIG. 1 to FIG. 6, the present disclosure provides a connector 10. The connector 10 is a high-speed connector. The connector 10 can be used in the connector field of servers. In one or more embodiments of the present disclosure, the connector 10 is a wire-end connector.

Furthermore, if this specification cannot clearly state the detailed design of the component and makes it impossible to implement, the design of the electrical device/connector designed in the CN108736186B patent can be used as a reference.

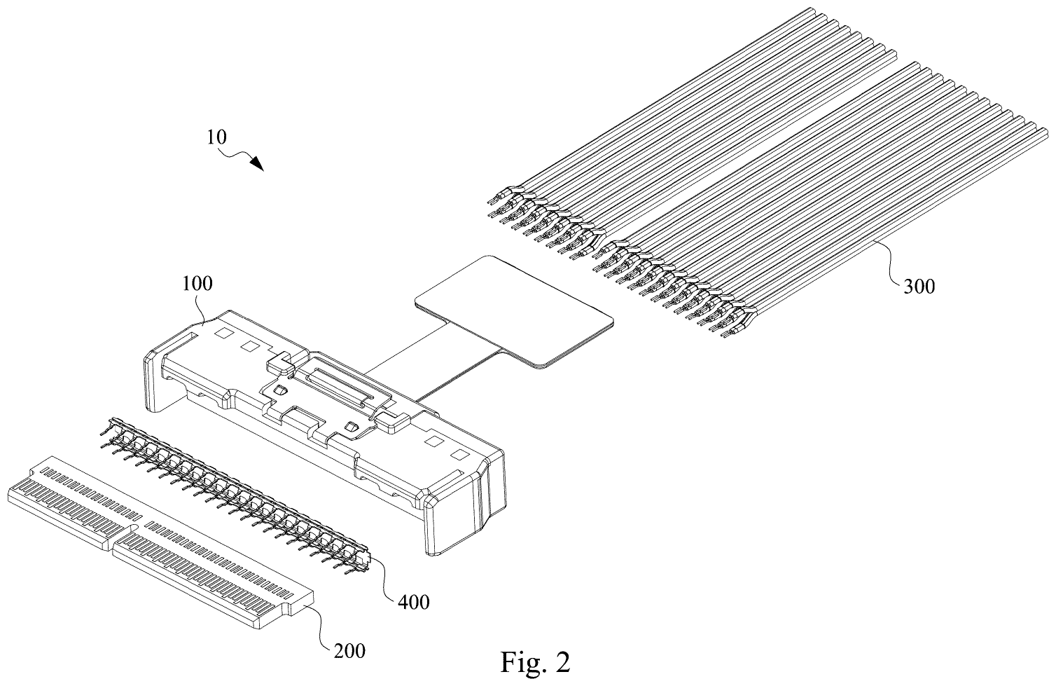

Please refer to FIG. 1 and FIG. 2 at the same time. FIG. 1 is a perspective view of the connector 10 according to an embodiment of the present disclosure. FIG. 2 is an exploded view of the connector 10 according to an embodiment of the present disclosure. In the present embodiment, the connector 10 includes a housing 100, a circuit board 200, signal wires 300, and a ground bar 400.

In some embodiments, when the connector 10 is to be connected to other electronic device (such as a server), the user can insert a plug end 104 into a corresponding port of the other electronic device. When wanting to pull out the connector 10 from the port of other electronic device, the user can pull out the connector 10 by pulling a handle 102.

Please continue to refer to FIG. 1 and FIG. 2. In some embodiments, the ground bar 400 clamps on the circuit board 200. The signal wires 300 pass through a sidewall of the ground bar 400 and are physically and electrically connected to the circuit board 200. The housing 100 surrounds the circuit board 200, end portions of the signal wires 300, and the ground bar 400.

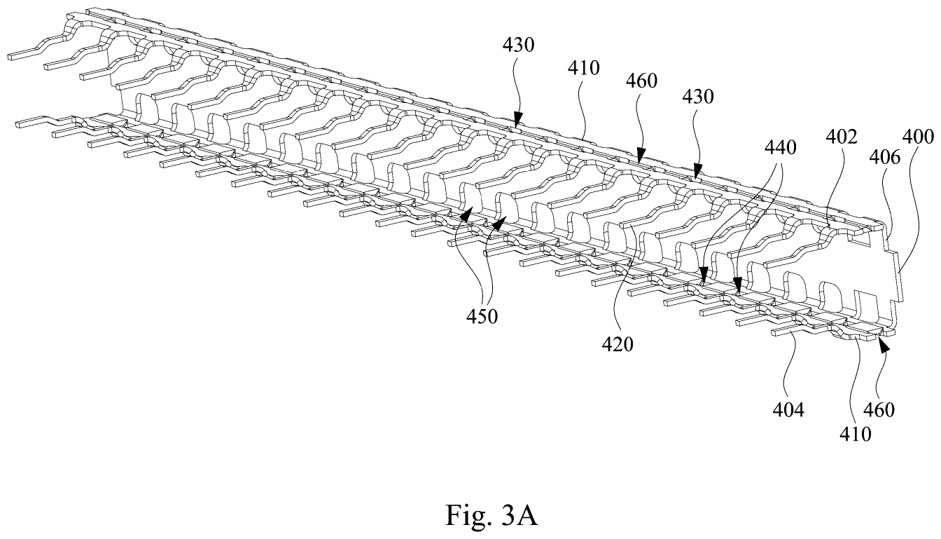

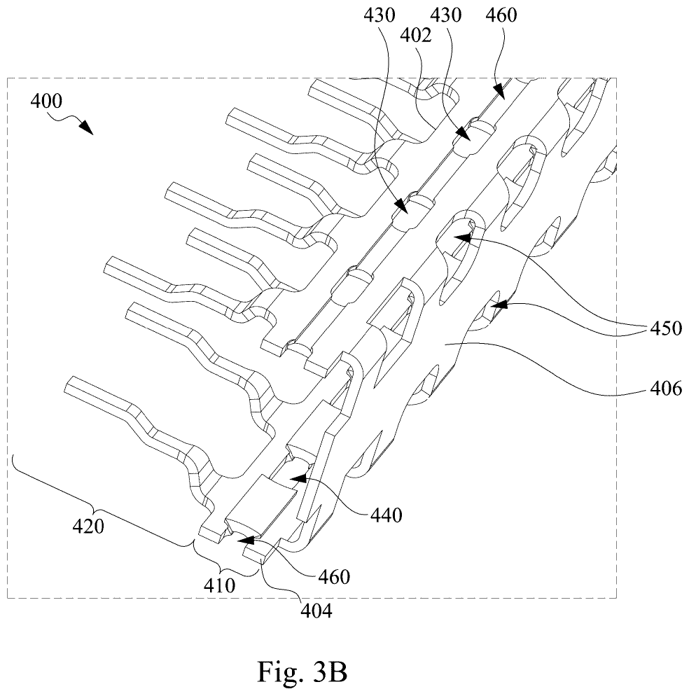

Please refer to FIG. 3A and FIG. 3B. FIG. 3A is a perspective view of the ground bar 400 according to an embodiment of the present disclosure. FIG. 3B is a partial perspective view of the ground bar 400 according to an embodiment of the present disclosure. In the present embodiment, the ground bar 400 includes an upper portion 402, a sidewall portion 406, and a lower portion 404. One end of the sidewall portion 406 is connected to the upper portion 402, and the other end on the opposite side is connected to the lower portion 404. Each of the upper portion 402 and the lower portion 404 includes a main panel 410 and a plurality of finger portions 420. The main panel 410 is connected to the sidewall portion 406.

The finger portions 420 are connected to the main panel 410. The finger portions 420 extend in a direction away from the main panel 410. The sidewall portion 406 has a plurality of through holes 450. There are upper soldering openings 430 on the main panel 410 of the upper portion 402. There are lower soldering openings 440 on the main panel 410 of the lower portion 404. The upper soldering openings 430 run through the main panel 410 of the upper portion 402. The lower soldering openings 440 run through the main panel 410 of the lower portion 404. The upper portion 402 and the lower portion 404 each have a solder groove 460. The solder groove 460 of the upper portion 402 is located on a side of the main panel 410 away from the lower portion 404. The solder groove 460 of the lower portion 404 is located on a side of the main panel 410 away from the upper portion 402. The solder groove 460 of the upper portion 402 is communicated with the plurality of upper soldering openings 430. The solder groove 460 of the lower portion 404 is communicated with the plurality of lower soldering openings 440.

In some embodiments, the through holes 450 are sequentially arranged in pairs on the sidewall portion 406 of the ground bar 400. One of each pair of the through holes 450 is adjacent to the upper portion 402, and the other of each pair of the through holes 450 is adjacent to the lower portion 404.

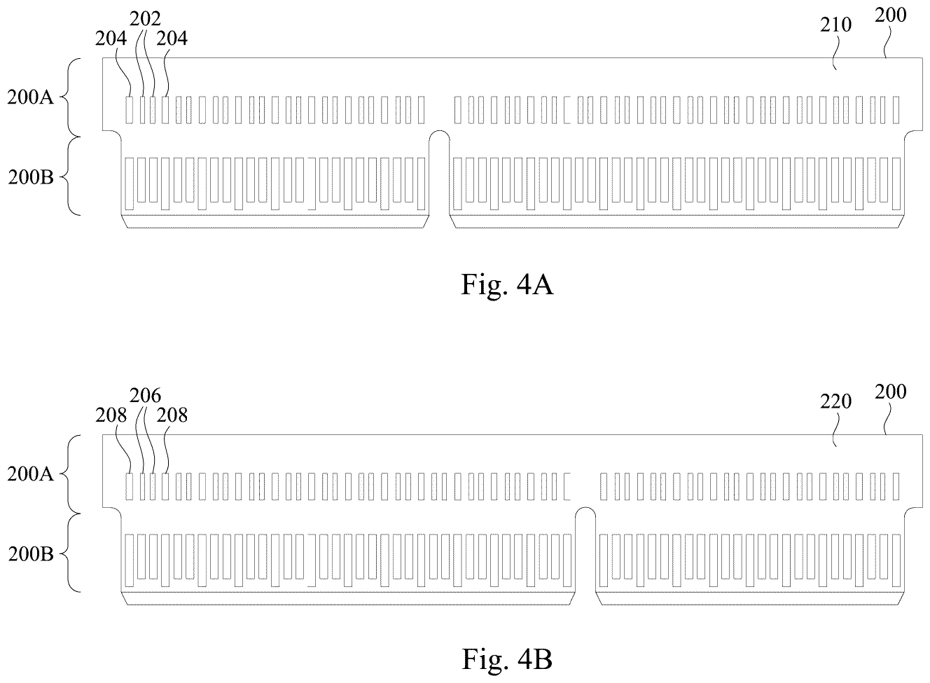

Please refer to FIG. 4A and FIG. 4B at the same time. FIG. 4A is a top view of the circuit board 200 according to an embodiment of the present disclosure. FIG. 4B is a bottom view of the circuit board 200 according to an embodiment of the present disclosure. In the present embodiment, the circuit board 200 has an upper surface 210 and a lower surface 220. The upper surface 210 and the lower surface 220 are located on opposite sides of the circuit board 200. The upper surface 210 and the lower surface 220 of the circuit board 200 each include a first region 200A and a second region 200B. The first region 200A may also be called a golden finger region. The first region 200A of the upper surface 210 includes upper signal contacts 202 for connecting the signal wires 300 and upper ground contacts 204 for connecting the finger portions 420. The first region 200A of the lower surface 220 includes lower signal contacts 206 for connecting to the signal wires 300 and lower ground contacts 208 for connecting to the finger portions 420. The second region 200B is used to electrically connect other electronic devices, such as a board-end connector of a server.

The structure of the signal wires 300 and how the signal wires 300 are mechanically and electrically connected to the circuit board 200 will be described in detail below.

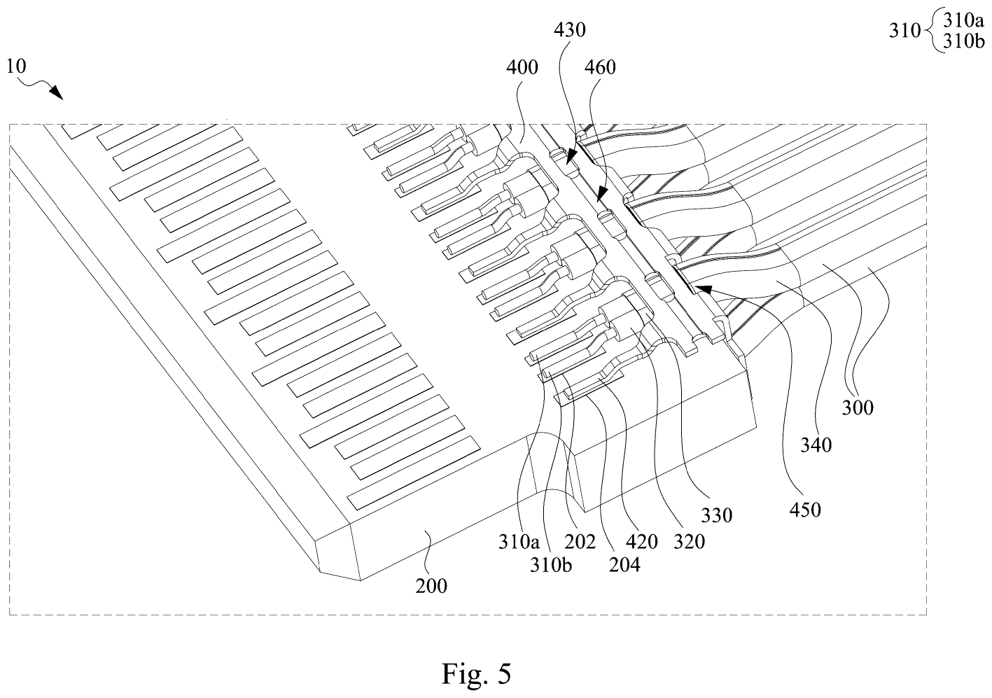

Please refer to FIG. 5. FIG. 5 is a partial perspective view of the connector 10 according to an embodiment of the present disclosure. For clarity of illustration, the housing 100 is not shown in FIG. 5. In the present embodiment, each of the signal wires 300 includes a pair of signal conductors 310a, 310b. The pair of signal conductors 310a, 310b is a differential pair 310. The terminal portions of the signal conductors 310a, 310b are electrically connected to and in direct contact with adjacent two of the upper signal contacts 202 respectively. Other portions of the signal conductors 310a, 310b except the terminal portions for contacting the signal contacts are surrounded and covered by an insulating layer 320. The insulating layer 320 is surrounded by a shielding film 330. The shielding film 330 is a metal film used for grounding and reducing signal interference. The shielding film 330 is exposed below the upper soldering openings 430. Some portions of the shielding film 330 away from the circuit board 200 are surrounded by one or more layers of cable sheaths 340.

In some embodiments, the signal conductors 310a, 310b of the differential pairs 310 of some signal wires 300 are respectively electrically connected to and in direct contact with adjacent two of the lower signal contacts 206 (see FIG. 4B). The manner in which the signal conductors 310a, 310b are connected to the two lower signal contacts 206 is similar to the manner in which the signal conductors 310a, 310b are connected to the two upper signal contacts 202 in FIG. 5, so it is not clearly illustrated.

How the ground bar 400 is electrically and mechanically connected to the circuit board 200 will be described in detail below.

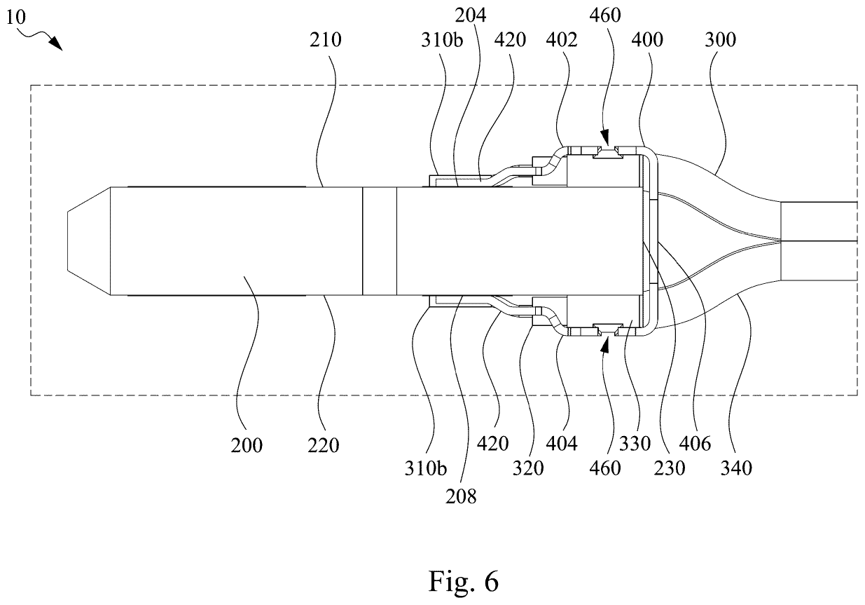

Please refer to FIG. 3A, FIG. 5, and FIG. 6 at the same time. FIG. 6 is a side view of the connector 10 according to an embodiment of the present disclosure. For clarity of illustration, the housing 100 is not shown in FIG. 6. In the present embodiment, the ground bar 400 has two sets of finger portions 420 that are respectively connected to the main panel 410 of the upper portion 402 and the main panel 410 of the lower portion 404. The finger portions 420 of the upper portion 402 are bent toward the circuit board 200 relative to the main panel 410 of the upper portion 402 and are in direct contact with the upper ground contacts 204. The finger portions 420 of the lower portion 404 are bent toward the circuit board 200 relative to the main panel 410 of the lower portion 404 and are in direct contact with the lower ground contacts 208. That is to say, the ground bar 400 is in connect with the upper ground contacts 204 and the lower ground contacts 208 of the circuit board 200 through the finger portions 420 of the upper portion 402 and the lower portion 404 respectively.

As shown in FIG. 6, in the present embodiment, the circuit board 200 has a side surface 230 connected to the upper surface 210 and the lower surface 220. Viewed from the side view, the ground bar 400 is a C-shaped structure. During processing, it needs to open the opening of the C-shaped structure and then clamp the circuit board 200. The upper portion 402 and the lower portion 404 of the ground bar 400 clamp the circuit board 200. In more detail, the upper portion 402 clamps on the upper surface 210 and the lower portion 404 clamps on the lower surface 220. The sidewall portion 406 faces or abuts against the side surface 230.

In this way, since the ground bar 400 has a clamping force, it can clamp the circuit board 200, which is more convenient during subsequent processing and manufacturing. For example, an upper and lower clamping machine can be used to simultaneously solder the finger portions 420 of the upper portion 402 and the lower portion 404 to the upper ground contacts 204 and the lower ground contacts 208 respectively. In other words, process efficiency can be improved.

The positional relationship between the signal wires 300 and the ground bar 400 will be described in detail below.

Please refer to FIG. 3B, FIG. 5, and FIG. 6 at the same time. In the present embodiment, the sidewall portion 406 of the ground bar 400 has a plurality of through holes 450. The through holes 450 are configured for the signal wires 300 to pass through. In more detail, one differential pair 310 of the signal wires 300 corresponds to one of the through holes 450. The through holes 450 make it easier to align the signal wires 300 and facilitate subsequent soldering.

Please refer to FIG. 3A and FIG. 5. In some embodiments, the finger portions 420 and the differential pairs 310 (each including a set of signal conductors 310a, 310b) are alternately arranged in the golden finger area of the circuit board 200. The finger portions 420 may isolate signal interference between the differential pairs 310.

Please continue to refer to FIG. 3B, FIG. 5, and FIG. 6. In the present embodiment, the main panel 410 of the ground bar 400 is located on a side of the signal wires 300 away from the circuit board 200. The main panel 410 of the ground bar 400 has a plurality of soldering openings, such as upper soldering openings 430 and lower soldering openings 440. One soldering opening corresponds to one differential pair 310. The soldering openings run through the main panel 410 and expose the underlying shielding film 330. The exposed portions of the shielding film 330 (the portions not covered by the cable sheath 340) are located between the upper portion 402 and the lower portion 404 of the ground bar 400.

The function of the solder groove 460 will be described in detail below.

Please refer to FIG. 3A, FIG. 3B, and FIG. 5. In the present embodiment, the soldering openings of the ground bar 400 (e.g., the upper soldering openings 430 and the lower soldering openings 440) will expose the shielding film 330. By filling the soldering openings with solder, the shielding film 330 and the ground bar 400 can be electrically connected. Since the solder groove 460 is communicated with the soldering openings located at the same location, the entire connector 10 can be baked in an oven after filling the solder groove 460 with the solder (e.g., soldering tin). For example, the solder groove 460 of the upper portion 402 is communicated with multiple (or all) upper soldering openings 430. By filling the solder groove 460 in the upper portion 402 with the solder and then baking, the ground bar 400 and the shielding film 330 of the signal wires 300 can be quickly soldered.

In some embodiments, the solder groove 460 extends along an edge of the upper portion 402 (or the lower portion 404) adjacent to the sidewall portion 406.

In some embodiments, the differential pairs 310 and the finger portions 420 of the present disclosure are soldered to the signal contacts (e.g., the upper signal contacts 202 and the lower signal contacts 206) and the ground contacts (e.g., the upper ground contacts 204 and the lower ground contacts 208) respectively using the solder.

To sum up, since the connector of the present disclosure includes a C-shaped structure of the ground bar, the ground bar is connected to the upper signal contacts and the lower signal contacts. Therefore, the ground bar can be clamped on the circuit board during the manufacturing process to facilitate soldering. In addition, since the ground bar has the solder groove connected to the soldering openings, solder filling is facilitated and the manufacturing process is streamlined.

The term “respectively” used in this description refers to having the same number of elements A and elements B and corresponding one-to-one. When the present disclosure describes “UNIT A is in contact with UNIT B,” it means that UNIT A abuts against UNIT B either directly or connects via an intermediary such as solder.

The foregoing description is merely illustrative and descriptive of exemplary embodiments of the present disclosure, and is not intended to be exhaustive or to limit the precise forms of the invention disclosed in the present disclosure. The above teachings may be modified or varied.

The embodiments are chosen and described in order to explain the contents of the present disclosure and their practical applications to thereby inspire others skilled in the art to utilize the disclosure and various embodiments and with various modifications as are suited to the particular use contemplated. Alternative embodiments will be apparent to those skilled in the art to which this disclosure belongs without departing from the spirit and scope of this disclosure. Therefore, the scope of the present disclosure is determined by the appended invention claims rather than by the foregoing specification and the exemplary embodiments described therein.

What is claimed is:

1. A connector, comprising:
a circuit board having an upper surface and a lower surface opposite to each other, the upper surface comprising a plurality of upper signal contacts and a plurality of upper ground contacts, the lower surface comprising a plurality of lower signal contacts and a plurality of lower ground contacts;
a plurality of signal wires, some of the signal wires being in contact with the upper signal contacts respectively, others of the signal wires being in contact with the lower signal contacts respectively; and
a ground bar in contact with the upper ground contacts and the lower ground contacts.

2. The connector of claim 1, wherein the ground bar comprises an upper portion, a sidewall portion, and a lower portion, the upper portion is in contact with the upper ground contacts, the sidewall portion is connected to the upper portion and the lower portion, and the lower portion is in contact with the lower ground contacts.

3. The connector of claim 2, wherein at least one of the signal wires comprises a differential pair and a shielding film surrounding the differential pair, and the shielding film is electrically connected to the ground bar and located between the upper portion and the lower portion.

4. The connector of claim 2, wherein at least one of the signal wires comprises a differential pair, the sidewall portion has a through hole corresponding to the differential pair, and the differential pair passes through the through hole and is electrically connected to the circuit board.

5. The connector of claim 2, wherein at least one of the upper portion and the lower portion comprises a main panel connected to the sidewall portion and a plurality of finger portions connected to the main panel, and the finger portions extend away from the sidewall portion.

6. The connector of claim 5, wherein the finger portions and the signal wires are arranged alternately.

7. The connector of claim 2, wherein the circuit board has a side surface connected to the upper surface and the lower surface, and the sidewall portion faces the side surface.

8. The connector of claim 1, wherein each of the signal wires comprises a differential pair and a shielding film surrounding the differential pair, the ground bar has a plurality of soldering openings, the soldering openings respectively correspond to the differential pairs, and the soldering openings expose the shielding film.

9. The connector of claim 8, wherein the ground bar further comprises at least one solder groove, and the at least one solder groove is communicated with the soldering openings.

10. The connector of claim 1, wherein the ground bar is a C-shaped structure, and two ends of the C-shaped structure clamp on the upper surface and the lower surface respectively.

11. A connector, comprising:
a circuit board having an upper surface and a lower surface opposite to each other, the upper surface comprising a plurality of upper signal contacts and a plurality of upper ground contacts, the lower surface comprising a plurality of lower signal contacts and a plurality of lower ground contacts; and
a ground bar, wherein two ends of the ground bar clamp on the upper surface and the lower surface respectively and are in contact with the upper ground contacts and the lower ground contacts respectively.

12. The connector of claim 11, wherein the ground bar comprises an upper portion, a sidewall portion, and a lower portion, the upper portion is in contact with the upper ground contacts, the sidewall portion is connected to the upper portion and the lower portion, and the lower portion is in contact with the lower ground contacts.

13. The connector of claim 12, wherein at least one of the upper portion and the lower portion comprises a main panel connected to the sidewall portion and a plurality of finger portions connected to the main panel, and the finger portions extend away from the sidewall portion.

14. The connector of claim 12, wherein the sidewall portion has a plurality of through holes, and the through holes are sequentially arranged in pairs on the sidewall portion.

15. The connector of claim 11, wherein the ground bar has a plurality of soldering openings and at least one solder groove communicated with the soldering openings.
